(19) United States
(12) Patent Application Publication
(10) Pub. No.: US 2006/0192659 A1
(43) Pub. Date: Aug. 31, 2006

(54) Spy guard system, photo vision and/or message notification system

(76) Inventor: Michele Paula Fazio, Hemlock, NY (US)

Correspondence Address: Michele Paula Fazio, 5143 Blank Rd, Hemlock, NY, 14466, US

(21) Appl. No.: 11/352,591

(22) Filed: Feb. 13, 2006

Related U.S. Application Data
(60) Provisional application No. 60/652,844, filed on Feb. 15, 2005.

(51) Int. Cl. B60R 25/10; B60Q 1/00; G08B 13/00

(52) U.S. Cl. 340/426.18; 340/565; 340/436

(57) ABSTRACT

Spy Guard System, photo vision and/or message notification alarm system. The instant invention is a modified micro camera that is similar to a vision camera cell phone with the technology for processing and transmitting data, photo's or short video's to a pre programmed destination. The instant invention is activated by a motion detector or when a car door or window is jarred. Transmits the photo's or short video's taken to a pre programmed vision cell phone, email address or Global Positioning Service destination upon activation. The alarm can work in conjunction with a sound horn or siren alarm if the user chooses to. The transmission process is through the paid service of a cell phone carrier using the transmitter frequencies and coding format of a cell phone service provider.

### CROSS REFERENCE TO RELATED APPLICATIONS

This application is based on provisional application serial number U.S. 60/652,844, filed on Feb.15, 2005.

Description of Attached Appendix

Not Applicable

### STATEMENT REGARDING FEDERALLY SPONSORED RESEARCH OR DEVELOPMENT

Not Applicable

### BACKGROUND OF THE INVENTION

This invention relates generally to the field of alarm systems and more specifically to Spy Guard System, photo vision and/or message notification system. This invention relates to the field of alarms and more specifically to a process for sending pictures to a pre programmed cell phone number, a email address or a global positioning service when the alarm is activated.

Alarm systems have been around for many years, for cars, homes and businesses etc. Most car and home alarms have a loud sound horn or siren alarm and unless they are connected to a security service directly when activated they very often go unreported because of the high false alarm rate especially in car alarm activations. As a result the owner(s) are not always aware that the alarm went off yet most alarm user's would like to know every time the alarm is activated whether it is a false alarm or not. There have been many attempts over the years to improve on the technology of alarm systems, anywhere from a car stalling device when a car shifts to a specific gear, while another improvement is the computer key chip that is installed by the car manufacturer(s) and is needed to start the car correctly and to be able to put the car in gear. Tracking device's is yet another improvement that has been made in more recent years through global positioning technology. Most recently to date a car alarm transmitting paging system is another improvement to car alarm systems. A search of prior art does not disclose a car alarm or house alarm systems that offer the claims of the instant invention of transmitting photo's to a pre programmed vision cell phone number or a email address within minutes if not seconds of an alarms activation and notification of an incident occurrence.

References Cited:

| | | |
|---|---|---|
| 5,049,867 | September 1991 | Stouffer |
| 5,334,974 | August 1994 | Simms, et al |
| 5,432,495 | July 1995 | Tomkins |
| 5,546,072 | August 1996 | Creuseremee, et al |
| 5,629,693 | May 1997 | Janky |
| 5,898,391 | April 1999 | Jefferies, et al |
| 5,900,805 | May 1999 | Knight |
| 6,028,506 | February 2000 | Xiao |
| 6,107,914 | August 2000 | Greene |
| 6,240,365 | May 2001 | Bunn |
| 6,252,509 | June 2001 | Hester |
| 6,480,098 | November 2002 | Flick |
| 6,956,467B1 | October 2005 | Mercado |

In review of prior technology cited they have not disclosed directly on the claims of the instant invention however some are somewhat related:

U.S. Pat. No. 5,049,867 issued to Stouffer, describes an anti-theft system which includes a starter interrupt which prevents the starting of the vehicle when the anti-theft system is armed and activated.

U.S. Pat. No. 5,334,974 issued to Simms, et al, describes a personal alarm system that communicates energy data and position coordinates and a central dispatch station receives the data and displays the position of the mobile unit on a digitized map.

U.S. Pat. No. 5,432,495 issued to Tomkins, describes a beeper control auto security system in which a disabling an ignition kill device switch and also discloses a vehicle motion detector that is also activated and turns on a monitor transmitter if the vehicle is moved, enabling detection by a portable monitor receiver carried by the owner or police vehicles.

U.S. Pat. No. 5,546,072 issued to Creuseremee, et al, describes an alert locator, a security system for monitoring an area under surveillance.

U.S. Pat. No. 5,629,693 issued to Janky, describes a locating reporting system for determining and reporting a missing vehicle present location.

U.S. Pat. No. 5,900,805 issued to Knight, describes a sensor car alarm with a siren and a anti theft device which turns the ignition switch to the off position.

U.S. Pat. No. 6,028,506 issued to Xiao, describes a car alarm and a paging system that improves a conventional phone pager which eliminates the need of carrying two pagers, one for normal use and the other for notification of the alarm activation.

U.S. Pat. No. 6,240,365 issued to Bunn, describes and automated vehicle tracking and service provision system with a central controller.

U.S. Pat. No. 6,252,509 issued to Hester, describes a remote controlled audio-visual alarm system for normally invisibly mounting in corner soffits of a house in which camera extends out upon activation of the alarm.

The instant invention improves considerably upon the prior art of alarms by providing a alarm system that combines the technology of an alarm system and the technology of a camera vision cell phone which gives visual notification and photo's of the incident of the occurrence directly to a vision cell phone or computer email address.

### BRIEF DESCRIPTION OF THE INVENTION

The primary object of the invention is A modified micro wireless alarm camera system that takes photo's or short video's when the alarm is activated.

Another object of the invention is The camera alarm then transmits photo's or a short video or text message to a pre programmed cell phone number when the alarm is activated.

Another object of the invention is The camera alarm then transmits photo's or a short video or text message to a pre programmed email address.

Another object of the invention is The camera transmits photo's or a short video to a pre programmed security service or a GPS—global positioning service when the alarm is activated.

A further object of the invention is it provides instant documentation of the time the incident occurred without the assistance of a security service.

Yet another object of the invention is it eliminates the costs of a security service fee.

Still yet another object of the invention is it can be a silent alarm or it can work in conjunction with a sound horn or siren alarm.

Another object of the invention is A wireless system is more secure and can't, be dismantled as readily as a wired system.

Other objects and advantages of the present invention will become apparent from the following descriptions, taken in connection with the accompanying drawings, wherein, by way of illustration an embodiment of the present invention is disclosed.

In accordance with a preferred embodiment of the invention, there is disclosed Spy Guard System, photo vision and/or message notification system comprising: A modified micro camera with the technology similar to a camera vision cell phone that takes photo's or short video's, with audio option, if system has a micro microphone, when the alarm is activated, (a) The instant invention is a modified micro camera that is similar to a camera vision cell phone with the technology for processing and transmitting data or photo's or short video's with a audio option to a pre programmed destination. (b) The instant invention is activated by a motion detector with a close range variation or when a car door or window is jarred. The instant invention transmits the photo's or short video's taken to a pre programmed vision cell phone, email address or Global Positioning Service destination,

In accordance with a preferred embodiment of the invention, there is disclosed a process for Spy Guar System, photo vision and/or message notification system comprising the steps of: A modified micro camera with the technology similar to a vision cell phone camera that takes photo's, or short video's with audio, if system is equipped with a micro microphone, when activated, Transmits the photo's taken to a pre programmed vision cell phone, email address or Global Positioning Service destination.

In accordance with a preferred embodiment of the invention, there is disclosed a modified micro web cam (with the possibiliy of a audio option) set-up installed in a property being protected, i.e. a car, house, yacht etc., that has the capability and the technology to be turned on by the user through the user's vision cell phone or a computer using a pre programmed pass code for the web cam camera(s) activation. This set-up can work with multiple camera's at the location be protected. This would mode would enable the user to check in and view the user's property using the user's vision cell phone on demand at anytime while away from their car or home.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a circle diagram of the transmission processing system.

FIG. 2 is a perspective view and flow example of the instant invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

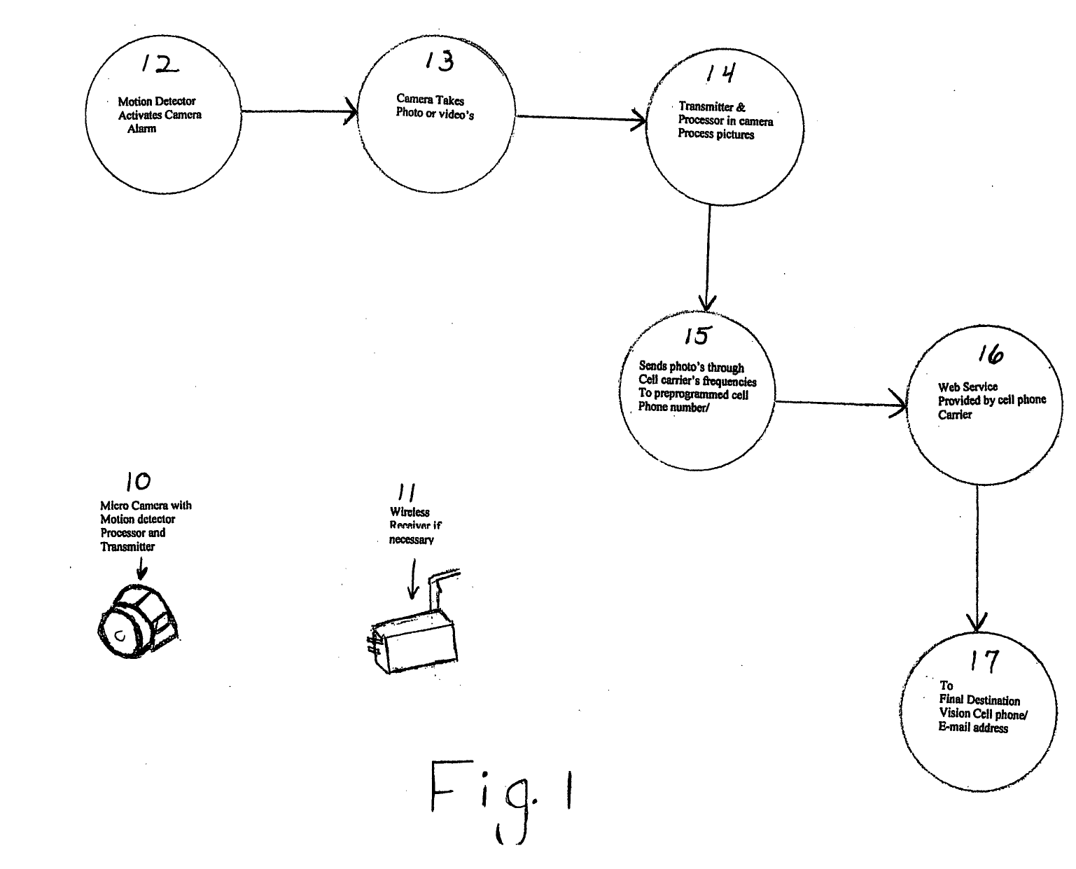

In accordance with the instant invention, FIG. 1 shows, the instant invention comprises a micro camera 10, with a built in motion detector, processor and transmitter, which can range in size of approximately a dime to approximately the size of a quarter in diameter and approximately an inch or so in depth. The transmission may need a wired or wireless receiver powered by battery 11, which can be put in a hidden location(s). The motion detector part of the camera activates the camera alarm 12, wherein the camera takes photo's or a short video with sound, if camera is quipped with a micro microphone, to be transmitted 13, the transmitter and processor in the camera processes the pictures the same way a camera vision cell phone processes photo's using the transmitter frequencies and coding format using the paid service of a cell phone carrier 14, the photo's are sent through the service of the cell phone carriers frequencies to a preprogrammed cell phone number, email address, security service etc. Utilizing the web service capabilities provided by the vision cell phone carrier 16, the preprogrammed final destination being, a vision dell phone, email address, security office or global positioning service etc. The user may choose to program a distinct ring or tone on the user's vision cell phone that identifies the alarm activation.

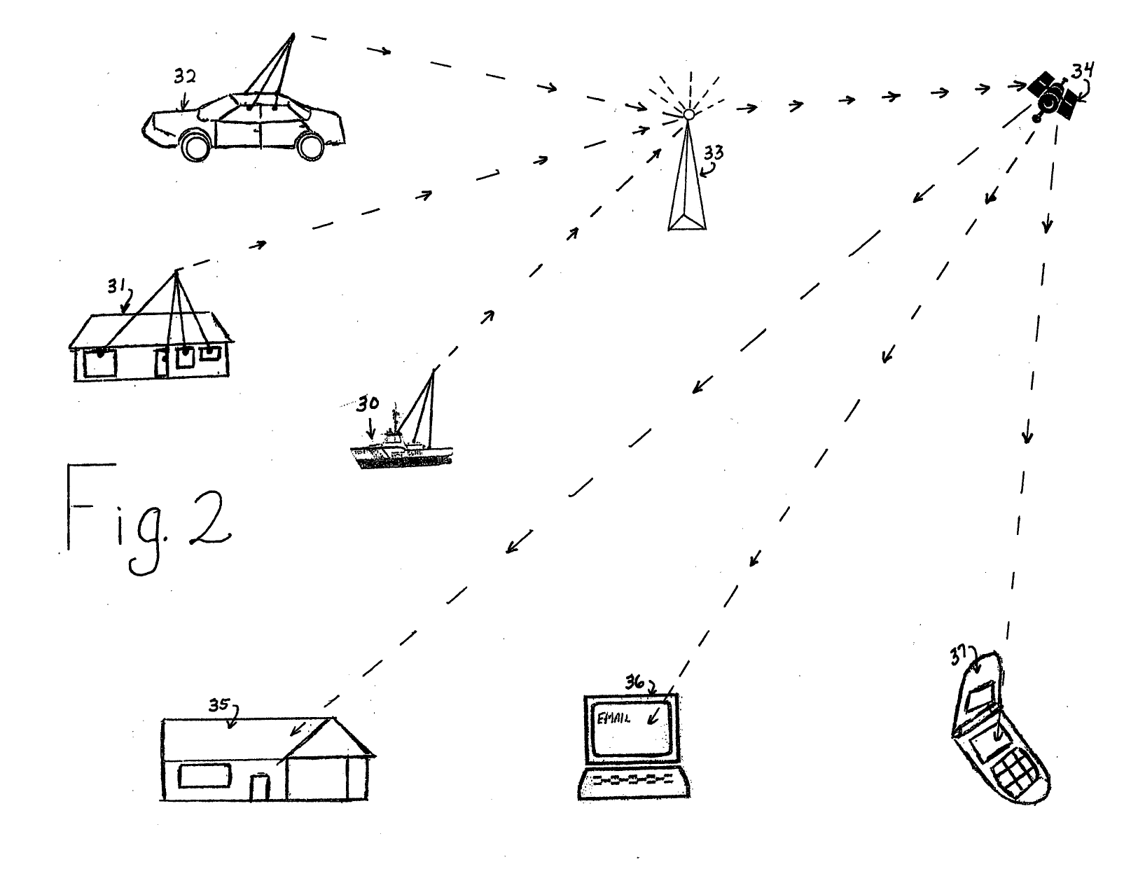

Turning to FIG. 2, depicts wireless micro camera(s) strategically located in a yacht, house, car, etc, 30, 31 & 32, which can be hidden from view of the naked eye. FIG. 2 shows the flow of transmission when activated. Once the camera alarm is activated by the motion detector or when a door or window is slightly jarred; the camera(s) take photo's or a short video with sound (depending on what the user programs it to do). The photo(s) most likely will be taken without the knowledge of the perpetrator if used as a silent alarm without working in conjunction with a sound horn or siren alarm. Within minutes of the photo's or short video's being taken they are then transmitted with the transmitter frequencies and coding format through the paid service of a cell phone service carrier connection route, tower shown 33. At this point the photo's or short video's are then sent to a satellite 34, for transmission to a final pre programmed destination being a security station 35, email address 36, or a vision cell phone 37 for notification to the owner or user of the alarm system that the alarm has activated with photo's and time there of. The user can program a distinct ring or tone on their vision cell phone 37, that would identify that the alarm has activated and that there is a email waiting. The instant invention can also work in conjunction with or without a sound horn or siren alarm.

The camera(s) in FIG. 2 strategically located in a yacht 30, house 31, car 32, can also be that of a web cam mode camera enabling to owner to reverse the system by calling the web cam up from a vision cell phone or a computer to turn on the web cams. The user can then have the opportunity to check in to view the property being protected by the alarm system on demand using a vision cell phone or a computer.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Spy Guard System, photo vision and/or message notification system comprising:
A modified micro camera with the technology similar to a camera vision cell phone that takes photo's or short video's, with audio option, if system has a micro microphone, when the alarm is activated;
(a) The instant invention is a modified micro camera that is similar to a camera vision cell phone with the technology for processing and transmitting data or photo's or short video's with a audio option to a pre programmed destination.
(b) The instant invention is activated by a motion detector or when a car door or window is jarred.
The instant invention transmits the photo's or short video's taken to a pre programmed vision cell phone, email address or Global Positioning Service destination;

2. A process for Spy Guar System, photo vision and/or message notification system comprising the steps of:
A modified micro camera with the technology similar to a vision cell phone camera that takes photo's, or short video's with audio, if system is equipped with a micro microphone, when activated;
Transmits the photo's taken to a pre programmed vision cell phone, email address or Global Positioning Service destination, using the transmitter frequencies and coding format, through a paid for service, cell phone carrier for connection route.

3. A modified micro web cam (with the possibiliy of a audio option) set-up installed in a property being protected, i.e. a car, house, yacht etc., that has the capability and the technology to be turned on by the user through the user's vision cell phone or a computer using a pre programmed pass code for the web cam camera(s) activation. This set-up can work with multiple camera's at the location be protected. This would enable the user to check in and view the user's property using the user's vision cell phone on demand at anytime while away from their car, home or property being protected.
